(19) United States
(12) Patent Application Publication
(10) Pub. No.: US 2006/0224985 A1
(43) Pub. Date: Oct. 5, 2006

(54) Method of displaying an event in a mobile terminal and mobile terminal implementing the same

(75) Inventors: Su-A Baek, Gumi-si (KR); Kyoung-Ae Lim, Seoul (KR); Seung-Chul Choi, Suseong-gu (KR); Jae-Won Chang, Chilgok-gun (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/348,245

(22) Filed: Feb. 7, 2006

(30) Foreign Application Priority Data
Apr. 1, 2005 (KR) 2005-27726

(51) Int. Cl. G06F 9/00; G06F 3/00

(52) U.S. Cl. 715/764; 715/808; 715/835; 715/864

(57) ABSTRACT

A method of, and a mobile terminal configured for, efficiently displaying an event indication in the form of a pop-up box during idle mode of a mobile terminal is provided. Upon generation of an event, an event pop-up box indicates the occurrence of the event, and the event is displayed with the highest priority. For this purpose, it is determined whether an event pop-up box indicating the occurrence of the event exists. When the event pop-up box already exists, the event pop-up box is updated with information about the event and displayed with the highest priority. When the event pop-up box does not exist, the event pop-up box is generated.

### PRIORITY

This application claims the benefit under 35 U.S.C. § 119(a) of Korean Patent Application No. 2005-27726, filed in the Korean Intellectual Property Office on Apr. 1, 2005, the entire disclosure of which is hereby incorporated by reference.

### BACKGROUND OF THE INVENTION

1. Field of the Invention

The present invention relates generally to a method of, and a mobile terminal configured for, more efficiently displaying indications of occurrences of various events generated in a mobile terminal in the form of pop-up boxes. More particularly, the present invention relates to a method of, and a mobile terminal configured for, upon occurrence of an event, displaying an event pop-up box to indicate the occurrence of the event.

2. Description of the Related Art

In recent years, the development of mobile communication technology has enabled mobile terminals to exchange a variety of messages beyond traditional phone calls, including Short Messaging Service (SMS) messages, Multimedia Messaging Service (MMS) messages, and e-mail. Also, mobile terminals can provide Caller Identification (CID) service so that callers can be identified.

When a message event or a missed call occurs while the mobile terminal is in an idle mode, an event indication indicating the occurrence of an event appears on a Liquid Crystal Display (LCD) window until a user presses a predetermined key, such as an OK button.

According to a conventional event indication method, when two different message events occur successively, a conventional mobile terminal displays only an indication of occurrence of the latter event on the LCD window, although the user has not checked the former event. For instance, when a call from 010-123-4567 is missed, the user is alerted of the missed call during an idle mode of the mobile terminal, as illustrated in FIG. 1A. If an SMS message is received and the missed call still has not been checked, the mobile terminal substitutes an incoming SMS message indication for the missed call indication in the LCD window, as illustrated in FIG. 1B.

One drawback with the conventional event indication method is that a user is not effectively notified when a plurality of incoming events occur. Since only an indication of the latest incoming event appears in the LCD window, at any given time the user does not know the quantity and type of incoming events that have occurred. Further, another drawback is that the user does not know the previous event until he checks the latest incoming event because only the latest incoming event is indicated.

Accordingly, what is needed is a method to more effectively notify users of incoming events in mobile terminals.

### SUMMARY OF THE INVENTION

An object of the present invention is to address at least the above problems and disadvantages and to provide at least the advantages below. Accordingly, an object of the present invention is to provide a method of, and a mobile terminal configured for, displaying information about more than a single event upon occurrences of multiple events in an idle mode.

Another object of the present invention is to provide a method of more effectively notifying a user of the occurrence of incoming events in a mobile terminal.

A further object of the present invention is to provide a user-friendly user interface by providing an algorithm for displaying information about a plurality of incoming events in a mobile terminal upon generation of the incoming events.

The above objects are achieved by providing a method of, and a mobile terminal configured for, efficiently displaying an event indication in the form of a pop-up box during an idle mode of a mobile terminal. In the method, an event pop-up box indicating the occurrence of an event is displayed with the highest priority. For this purpose, it is determined whether an event pop-up box indicating the occurrence of the event exists. In the presence of the event pop-up box, the event pop-up box is updated with information about the event and displayed with the highest priority.

### BRIEF DESCRIPTION OF THE DRAWINGS

The above and other exemplary objects, features and advantages of the present invention will become more apparent from the following detailed description when taken in conjunction with the accompanying drawings, in which:

FIGS. 1A and 1B illustrate conventional event indications on an LCD window;

FIG. 2 shows a block diagram of a mobile terminal according to an exemplary embodiment of the present invention;

FIG. 3 shows a flowchart illustrating an operation for displaying an event indication in the mobile terminal according to an exemplary embodiment of the present invention;

FIGS. 4A, 4B and 4C illustrate a sequence of event pop-up box generation on an LCD window;

FIGS. 5A and 5B illustrate a sequence of event pop-up box deletion the LCD window; and

FIGS. 6A to 6H illustrate a plurality of arranged pop-up boxes on the LCD window.

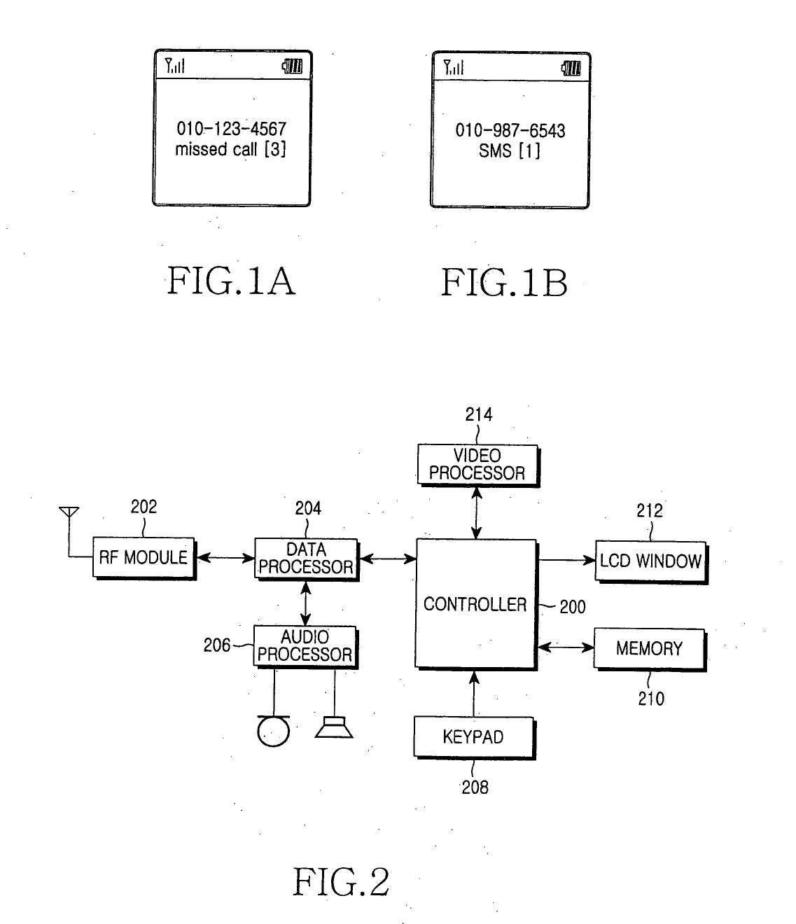

Throughout the drawings, like reference numbers should be understood to refer to like elements, features, and structures.

### DETAILED DESCRIPTION OF EXEMPLARY EMBODIMENTS

The matters exemplified in this description are provided to assist in a comprehensive understanding of various exemplary embodiments of the present invention disclosed with reference to the accompanying figures. Accordingly, those of ordinary skill in the art will recognize that various changes and modifications of the exemplary embodiments described herein can be made without departing from the scope and spirit of the claimed invention. Descriptions of well-known functions and constructions are omitted for clarity and conciseness.

FIG. 2 shows a block diagram of a mobile terminal according to an exemplary embodiment of the present invention. In reference to FIG. 2, the mobile terminal includes a controller 200, a Radio Frequency (RF) module 202, a data processor 204, an audio processor 206, a keypad 208, a memory 210, an LCD window 212, and a video processor 214.

The RF module 202 implements the radio communication functionality of the mobile terminal. The RF module 202 includes an RF transmitter (not shown) for upconverting and amplifying a transmission signal and an RF receiver (not shown) for low-noise-amplifying and downconverting a received signal.

The data processor 204 is provided with a transmitter (not shown) for encoding and modulating the transmission signal and a receiver (not shown) for demodulating and decoding the received signal. Thus, the data processor 204 can be composed of a Modulator-DEModulator (MODEM) and a Coder-DECoder (CODEC). The CODEC refers to a data CODEC for processing packet data and an audio CODEC for processing an audio signal such as voice.

The audio processor 206 reproduces an audio signal received from the audio CODEC of the data processor 204 through a speaker, and provides a transmission audio signal generated from a microphone to the audio CODEC of the data processor 204.

The memory 210 may include a program memory and a data memory. The program memory stores programs for controlling the typical operations of the mobile terminal and the data memory temporarily stores data generated during the operations of the mobile terminal.

The LCD window 212 displays a video signal received from the video processor 214 and user data received from the controller 200. In one exemplary embodiment, the LCD window 212 displays information about a variety of events in pop-up boxes during an idle mode under the control of the controller 200 so that a user can easily find out the generated events.

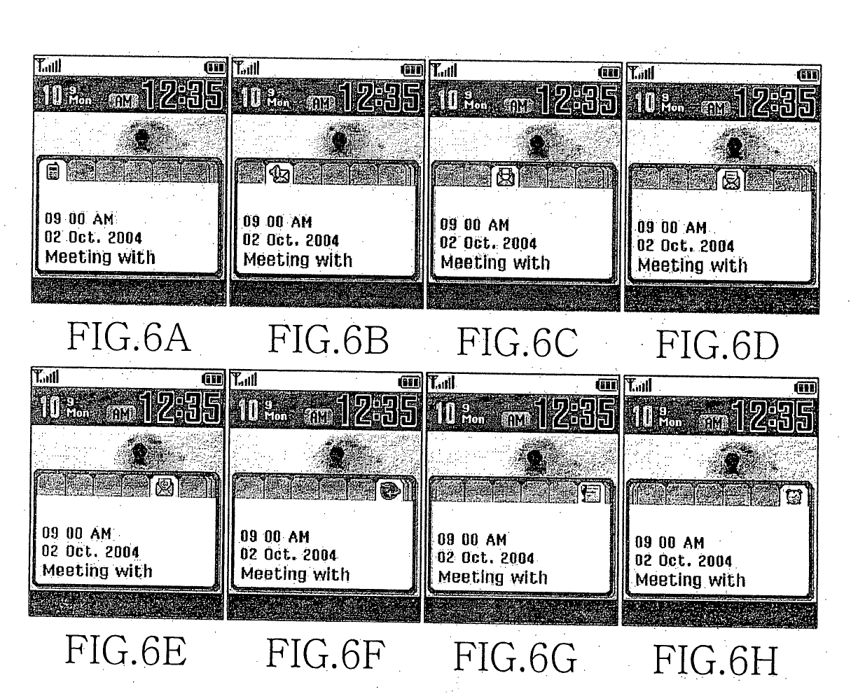

Users are notified of various events by corresponding event pop-up boxes as illustrated in FIGS. 6A to 6H. Each event pop-up box provides information about a corresponding event including its date and time.

The video processor 214 generates visual data by which to display a video signal. The video processor 214 processes video data received from a camera module (not shown) or memory 210 on a frame basis and outputs the frame video data according to the characteristics and size of the LCD window 212. The video processor 214 also includes a video CODEC for pressing the frame video data in a predetermined method or decompressing the compressed frame video data to the original frame video data. The video CODEC can be, for example, a JPEG CODEC, an MPEG4 CODEC, a Wavelet CODEC, or any other type of CODEC.

The keypad 208 has alphanumerical and function keys for invoking functions. The user can select an event pop-up box to be activated using directional keys.

The controller 200 provides overall control of the operation of the mobile terminal according to an exemplary embodiment of the present invention. Upon generation of an event during an idle mode, the controller 200 determines whether an event pop-up box showing information about the event exists. If it exists, the controller 200 updates the event pop-up box with the information about the event. The controller 200 also directs LCD window 212 to display the updated event pop-up box with the highest priority.

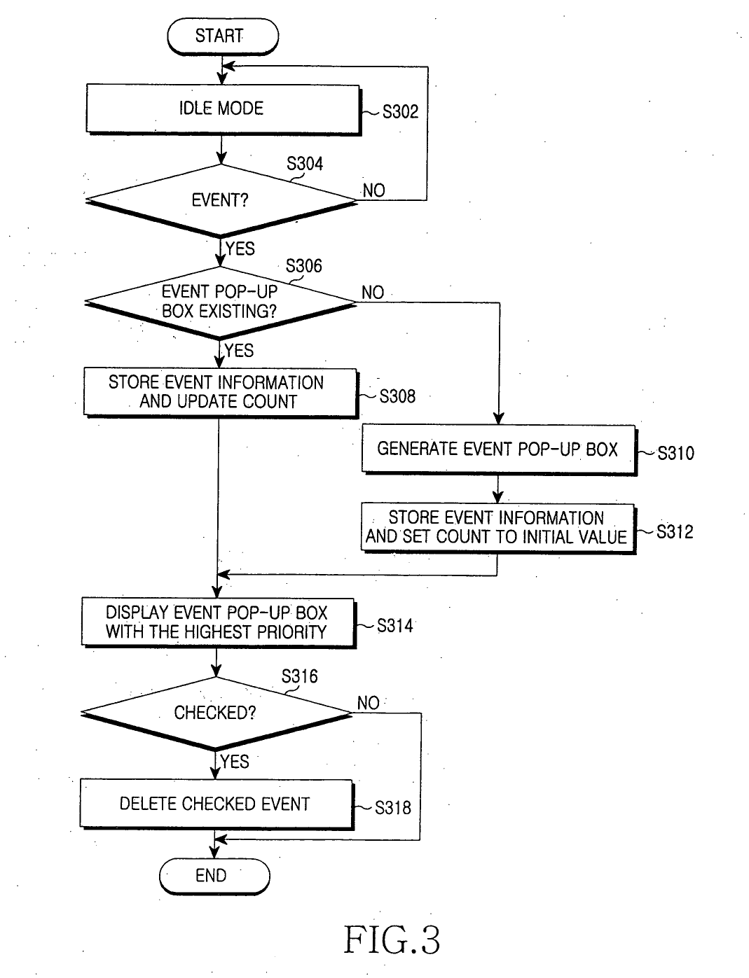

FIG. 3 shows a flowchart illustrating an operation for displaying an event indication in the mobile terminal according to an exemplary embodiment of the present invention.

Referring to FIGS. 2 and 3, the mobile terminal is in idle mode in step S302 and the controller 200 determines whether an event has occurred during idle mode in step S304. The event can be, for example, a missed call, a voice mail event, an SMS event, an MMS event, a schedule event, or a Digital Rights Management (DRM) event.

A missed call is an incoming call that was not answered normally, a voice mail event is reception of a voice message, an SMS event is reception of text of a predetermined size, an MMS event is reception of a message capable of carrying multimedia data as with a European GSM phone, a schedule event is an alarm notifying the user of a registered schedule at a registered time, and a DRM event is reception of an authentication key for a copyrighted multimedia file.

Each event is processed by a corresponding task processor. The task processor is a software module for performing a corresponding function. Each task processor monitors generation of a corresponding event under the control of an Operating System (OS). Upon generation of an event, the task processor notifies the main processor of the controller 200 of the event occurrences.

For example, upon generation of a missed call event, a call task processor notifies the main processor of the controller 200 of the missed call event. Each task processor and the main processor are activated in the controller 200. In the following exemplary embodiments, the controller 200 performs the operational algorithms of the task processors and the main processor.

On the occurrence of an event, that is, when a task processor reports generation of an event to the controller 200, the controller 200 determines whether an event pop-up box containing information about the event exists in step S306.

The event pop-up box is a display tool allocated according to event type. It is a display folder in concept. For example, when a plurality of missed call events are generated, the missed call events are indicated in a missed call event pop-up box. When a plurality of voice mail events occur, the voice mail events are indicated in a voice mail event pop-up box.

In accordance with an exemplary embodiment of the present invention, the following event pop-up boxes are representative of those that can be defined: a missed call event pop-up box for indicating missed calls, a voice mail event pop-up box for indicating reception of voice mails, an SMS event pop-up box for indicating reception of SMS messages, an MMS event pop-up box for indicating reception of MMS messages, a schedule event pop-up box for alerting the user of scheduled events, and a DRM event pop-up box for indicating DRM events.

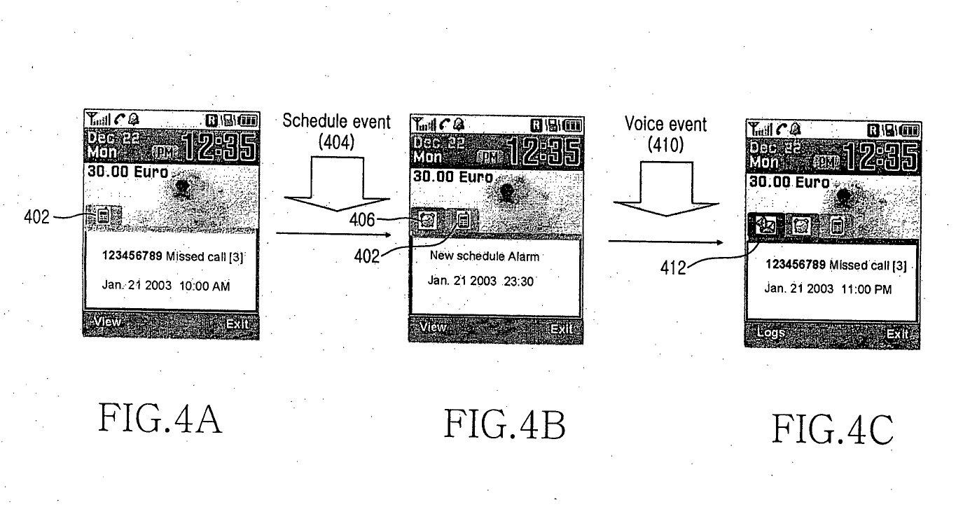

Step S306 is performed to check whether the incoming event is of the same type as an event indicated by an existing event pop-up box displayed on the LCD window 212. For example, if the user did not check the previous missed calls, the controller 200 displays a missed call event pop-up box 402 (FIG. 4A) on the LCD window 212 to indicate missed calls. Upon generation of a schedule event in this state, the controller 200 determines whether a schedule event pop-up box exists on the LCD window 212 to indicate the schedule event.

In the presence of a corresponding event pop-up box, the controller 200 updates the event pop-up box with information about the generated event in step S308. After updating the event pop-up box, the controller 200 increases the count indicating the total number of events in the event pop-up box. That is, the count indicates the total number of events that the user has not checked in the event pop-up box. For instance, if the user has not checked three voice mails indicated in the voice mail pop-up box, the event count is 3. Upon generation of a new voice mail event with the three voice mail messages unchecked, the event count of the voice mail event pop-up box is increased to 4. The event information refers to the contents and the date and time of the event. A variety of additional information can also be included in the event information.

The controller 200 displays the updated event pop-up box on the LCD window 212 with the highest priority in step S314. That is, the controller 200 displays information about the latest event and the count on the LCD window 212 during idle mode, after storing the event information and updating the event count in the event pop-up box. Here, the controller 200 displays the latest event information with the highest priority in pop-up form using an index list. When a new schedule event 404 (FIG. 4A) occurs subsequent to the missed call event, pop-up box 402 is displayed at index 1 on LCD window 212, and schedule event pop-up box 406 is activated with priority to show information about the schedule event, as illustrated in FIG. 4B. Similarly, when a new voice mail event is generated 410, a voice mail event pop-up box 412 is activated first on the LCD window 212, as illustrated in FIG. 4C.

On the other hand, in the absence of the corresponding existing event pop-up box in step S306, an event pop-up box to indicate the event is generated in step S310. After the event pop-up box is generated, the controller 200 shows information about event in the event pop-up box and sets the count to an initial value in step S312. Since the event is the first to be indicated in the event pop-up box, the count is set to 1. It is preferred that the count is set to the number of generated events.

In step S316, the controller 200 determines whether the user has checked the indicated event. If the user has not checked the event, the controller 200 displays all created event pop-up boxes to allow the user to view the events in an organized manner as illustrated in FIG. 4C, even though the mobile terminal is turned on again or the LCD window 212 is activated again. If the user has checked the event, the controller 200 deletes the checked event information from the event pop-up box and decreases the count in step S318. It can be noted that the event deletion means deletion of the event indication from the event pop-up box, not complete deletion of the event information. The actual event information is stored in a predetermined area of the memory 210, and can be deleted completely from a corresponding event folder within memory 210 using a separately configured menu.

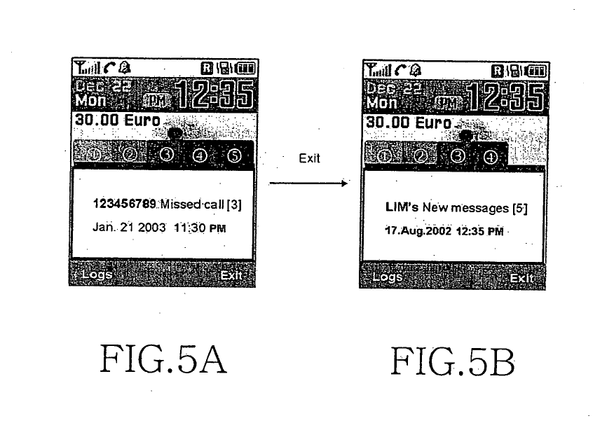

The event pop-up box displayed during idle mode can be deleted from the LCD window 212. When a predetermined command such as, for example, “EXIT” is selected with the event pop-up box activated as illustrated in FIG. 5A, the current event pop-up box disappears as illustrated in FIG. 5B.

If many event pop-up boxes are to be displayed on the LCD window 212, only a predetermined number of event pop-up boxes are displayed as indexes, as illustrated in FIGS. 6A to 6E, while the other event pop-up boxes are displayed as tabs. If a user wants to active a particular event pop-up box, he selects it using keypad 208. For example, when the user selects a right directional key on the LCD window 212 illustrated in FIG. 6A, the controller 200 activates the second event pop-up box as illustrated in FIG. 6B. When a user selects the right directional key again on the LCD window 212, illustrated in FIG. 6B, the controller 200 activates the third event pop-up box, as illustrated in FIG. 6C, and so on as illustrated in FIGS. 6D to 6H. When the user selects a left directional key on the LCD window 212, the controller 200 activates the previous event pop-up box.

In accordance with various exemplary embodiments of the present invention as described above, since events are indicated in the form of pop-up boxes during idle mode of a mobile terminal, and a user can easily view the event indications. Also, the event pop-up box generation and deletion algorithm according to one exemplary embodiment of the present invention leads to efficient event pop-up box management.

While the invention has been shown and described with reference to certain exemplary embodiments thereof, it will be understood by those of ordinary skill in the art that various changes in form and detail may be made therein without departing from the spirit and scope of the present invention as defined by the appended claims.

What is claimed is:

1. A method of displaying an event indication in a mobile terminal, the method comprising:
determining, upon occurrence of a second event in an idle mode, whether an event pop-up box indicating an occurrence of a first event exists;
when the event pop-up box indicating the occurrence of the first event exists, updating the event pop-up box with information indicating the occurrence of the second event; and
displaying the updated event pop-up box with the highest priority.

2. The method of claim 1, wherein the event comprises one of a missed call event, a voice mail event, a short messaging service (SMS) event, a multimedia messaging service (MMS) event, a schedule event, and a digital rights management (DRM) event.

3. The method of claim 1, wherein the event pop-up box comprises a count indicative of a number of occurred events, and the updating of the event pop-up box comprises:
updating the count based on the occurrence of the second event.

4. The method of claim 3, wherein displaying the updated event pop-up box comprises:
deleting information about an event from the event pop-up box when the event is checked in the displayed event pop-up box; and
decreasing the count by the number of the deleted events.

5. The method of claim 1, wherein the displaying of the updated event pop-up box comprises:
displaying a first number of event pop-up boxes as indexes; and
setting a second number of the event pop-up boxes as tabs for at least one end of an LCD window.

6. The method of claim 5, wherein displaying the updated event pop-up box further comprises:
moving the event pop-up box from a current activated event pop-up box according to a selected directional key; and
activating the event pop-up box in the new position.

7. The method of claim 1, wherein updating the event pop-up box comprises:
when the event pop-up box indicating the occurrence of the first event does not exist, generating the event pop-up box to indicate occurrence of the second event; and
updating the generated event pop-up box with information about the second event.

8. The method of claim 7, wherein the event pop-up box comprises a count indicative of a number of occurred events, and the updating of the event pop-up box further comprises:
updating the count based on the occurrence of the second event.

9. The method of claim 7, wherein the updating of the event pop-up box further comprises:
neglecting a key input event.

10. A mobile terminal comprising:
a display; and
a display generator configured to display an event pop-up box on the display,
wherein, if upon occurrence of a second event in an idle mode, the event pop-up box indicating an occurrence of a first event exists, the event pop-up box is updated with information indicating the occurrence of the second event, and the updated event pop-up box is displayed on the display with the highest priority.

11. The mobile terminal of claim 10, wherein, if upon occurrence of a second event in an idle mode, the event pop-up box indicating an occurrence of a first event does not exist, the event pop-up box is generated with information indicating the occurrence of the second event, and the generated event pop-up box is displayed on the display.
